(19) United States
(12) Patent Application Publication
(10) Pub. No.: US 2004/0145754 A1
(43) Pub. Date: Jul. 29, 2004

(54) Probe for non-destructive testing

(76) Inventors: Laurence Philip Dickinson, Carlingford (AU); Suszanne Thwaites, Lindfield (AU); Vivonne Thwaites, Henley Beach (AU); Stewart Wagner, Richmond (AU)

Correspondence Address: Richard J. Streit, Ladas & Parry, Suite 1200, 224 South Michigan Avenue, Chicago, IL, 60604, US

(21) Appl. No.: 10/688,755

(22) Filed: Oct. 17, 2003

Related U.S. Application Data
(63) Continuation-in-part of application No. PCT/AU02/00494, filed on Apr. 19, 2002.

(30) Foreign Application Priority Data
Apr. 20, 2001 (AU) PR 4507
Nov. 23, 2001 (AU) PR 9083
Dec. 13, 2001 (AU) PR 9516

(51) Int. Cl. G01B 11/14

(52) U.S. Cl. 356/614; 33/1 BB

(57) ABSTRACT

The present invention provides a probe for non-destructive testing of items. The probe is movable over a surface of a test item and includes a displacement sensor means for providing a displacement signal indicative of the spatial displacement of the probe over the test item as the probe is moved over the test item. The invention also provides the above-defined probe with a receiver for receiving a return signal from the non-destructive testing of the item and a non-destructive testing system comprising the probe.

### FIELD OF INVENTION

The present invention relates to a probe for use in the non-destructive testing of materials, and, particularly, but not exclusively, to a probe for use in the non-destructive testing (NDT) of structures and composite materials.

### BACKGROUND OF THE INVENTION

Non-destructive testing (NDT) is used to test a number of materials, in particular composite materials, such as utilised to manufacture aircraft and other items. It is not feasible to test items such as an aircraft for damage by disassembling the aircraft first. The testing needs to be non-destructive. Generally, but not exclusively, acoustic and near ultrasonic frequencies are used for NDT.

A typical NDT system is the pitch/catch system, employing a pitch/catch probe. A schematic cross-section through a typical pitch/catch probe showing the fundamental elements of such a probe is illustrated in FIG. 4. The pitch/catch probe 20 includes first 21 and second 22 probe assemblies. The probe assemblies include respective contact tips 23 and 24 which are spring loaded by springs 25 and 26 to contact a test sample 27. Each probe assembly 21 and 22 is equipped with a transducer 28, 29 such that one can act as a driver and the other as a detector (the operation may be interchangeable). The available drive frequency range is wide, typically 1 to 70 kHz. The drive signal is generally a short wave train, up to 6 cycles of sinusoid at a user selected frequency within the above range. The drive signal may alternatively be impulse or step excitation. The detector measures a response of the test sample 27 at its contact point. The theory is that the propagation of the disturbance from the drive to the detector is influence by the nature of the intervening structure and in particular, by any damage or anomaly in this region.

A return signal detected from a damaged test sample is compared with that from a “good” test sample (to give a reference signal) to determine the extent of any damage to the test sample. In conventional systems, complex electronic hardware is utilised to process the signals and provide a display of the return signal to enable determination of the damage. These systems are often expensive and the equipment is usually bulky.

In operation, testing will actually be carried out in situ on the item being tested (for example, an aeroplane). The pitch/catch probe is passed over the surface of the panels of the item being tested, and readings are taken from a plurality of points across the panel. Typical pitch/catch probes are hand held and move from one place to another over material being tested whilst viewing the result on a graphical readout.

Often, a reference frame is required so that positional information can be obtained from the probe. In the prior art systems, this positional information is acquired by attaching a part of a track or gantry to the item being tested, to which the probe can be attached and which provides a readout of the measuring position. The attachment of such gantry apparatus to the surface of an item such as an aircraft is difficult and time consuming.

### SUMMARY OF THE INVENTION

The present invention provides in a first aspect a probe for non-destructive testing of items, the probe being movable and rotatable over the surface of a test item and including a receiver for receiving a return signal from the non-destructive testing of the item and including displacement means for providing a displacement signal indicative of the spatial displacement of the probe over the test item as the probe is moved over the test item and the displacement means being arranged to provide information on the rotational orientation of the probe if the probe is rotated.

The displacement means may include a sensor mounted to the probe and being capable of providing the displacement signal and information on the rotational orientation. This information can be used to compensate for any rotation of the probe (which may occur naturally as the user moves the probe over the test item) from effecting the displacement information.

The sensor may be similar to sensors provided in computer “mice” for driving the computer graphical user interface (GUI). The sensor may be any type of mouse sensor and in a specific embodiment is an optical sensor (as used in so-called “optical mice”). Two sensors may be provided to enable provision of the orientation information.

In one embodiment, a pair of optical sensors are utilised in the probe. The pair of optical sensors are arranged to provide the orientation information.

The probe may advantageously have no need of a separate gantry or reference frame to enable the provision of positional information to an NDT processing system.

In another embodiment the probe comprises non-destructive-testing (NDT) data acquisition, processing and analysis electronics in one housing. The probe, together with a computer for data storage and data display, may form a complete NDT system. The probe may be operatively connectable with the computer using a single universal serial bus (USB) cable. In this case the USB cable may also be used to supply electrical power. Alternatively, the probe may be operatively connectable with the computer using a radio USB connection. This embodiment has a significant commercial advantage, as the probe is readily connectable to a typical standard computer. No modifications of the computer may be required and the computer does not need to be equipped with any special cards such as data acquisition cards. The probe may be connected to any typical standard PC computer via a USB port which has a significant commercial advantage. Further, the probe may be given a compact design similar to that of a computer mouse which has additional practical advantages.

As a variation of this embodiment, the probe may also comprise a computer memory for data storage in one housing. In this case a connection to an external computer may only be required for data transfer. The probe may also comprise a display and may form a complete NDT system.

In an alternative embodiment a system is provided for processing the signals provided by the probe. The system may be similar to the graphical user interface systems which are provided for processing positional information from computer mice.

The present invention provides in a second aspect a probe for non-destructive testing of items, the probe being arranged to provide positional information of displacement of the probe over the item, the probe being movable and rotatable over the surface of the item and including a displacement sensor means for providing a displacement signal indicative of the spatial displacement sensor means also being arranged to provide information on the rotational orientation of the probe if the probe is rotated.

The apparatus may include a suitable computing system programmed with suitable software to implement the probe position processing.

The present invention provides in a third aspect a non-destructive testing system comprising a probe as discussed above in combination with an apparatus for processing the probe signal as discussed above.

The present invention provides in a fourth aspect a probe for non-destructive testing of items, the probe comprising data acquisition, processing and analysis electronics in one housing and the probe forming, in combination with a typical standard computer, a useable NDT system.

The present invention provides in a fifth aspect a probe for non-destructive testing of items, the probe being movable over the surface of a test item and comprising

a receiver for receiving a return signal for the non-destructive testing of the item,

a displacement means for providing a displacement signal indicative of the spatial displacement of the probe over the test item as the probe is moved over the test item and

a support structure for holding the displacement means over the surface of the test item,

wherein the support structure and the displacement means are coupled in a manner so that the displacement means is moveable relative to the support structure.

For many displacements systems, including optical displacement systems, it is important to keep the distance between the displacement system and the surface of the test item as constant as possible. For example, a typical optical displacement system has a distance tolerance of approximately only 0.5 mm. However, typical test items, such as aircraft panels, often have different surface curvatures which makes it very difficult to maintain this tolerance when the probe is scanned over the panel. As the displacement means is moveable relative to the support structure, for example in a direction towards or away from the surface of the test sample, it may be possible for the displacement means to follow a curvature of a test sample even if the curvature is changing.

For example, the support structure may have three legs with feet that are arranged in a tripod arrangement. Such an arrangement has the particular advantage that the support structure may follow surface curvatures in a relatively easy and stable manner when the probe is moved over the surface. The displacement means may be positioned over a central portion of the area circumscribed by the feet. The test item may have a curved surface and the curvature may change across the surface. When the probe is moved over the surface and the three feet are in contact with the surface, the displacement means may, if the curvature is suitable, move up or down relative to the support structure to follow the curvature. It is therefore easier to meet the small distance tolerances required by a range of displacement means including optical devices such as those currently used in a so called “optical” computer mouse when curved surfaces are scanned.

The displacement means may include a housing and a displacement sensor such as an “optical” sensor positioned in the housing. In a specific embodiment the housing of the displacement means has a lower surface and the support structure may be arranged to hold the lower surface of the housing on the surface of the test item.

The probe may have a flexible coupling between the displacement means and the support structure. In a particular embodiment the flexible coupling allows movement of the displacement means in any direction.

The probe may be arranged so that in use the three feet slide across the surface of a curved test item, such as an aircraft panel, and the lower surface of the displacement means maintains contact with the surface even if the curvature of the surface is changing.

The probe may also comprise a handle portion that may be connected to the support structure. The connection may be pivotable and may comprise a universal joint.

The handle portion may be connected to the support structure so that the area circumscribed by support positions at which in use the support structure contacts the surface of the test item has a diameter larger than the height of the pivotable connection over the area. This particular geometrical arrangement has the advantage that the likelihood of tipping the probe over when the probe is moved over the surface of the test item is reduced.

The present invention provides in a sixth aspect a probe for non-destructive testing of items, the probe being movable over the surface of a test item and comprising

a receiver for receiving a return signal for the non-destructive testing of the item and

a displacement means for providing a displacement signal indicative of the spatial displacement of the probe over the test item as the probe is moved over the test item and

a support structure for holding the displacement means over the surface of the test item,

such that, when the support structure is moved over the surface of the test item, a substantially constant distance is maintained between the displacement means and the surface of the test item.

The support structure and the displacement means may be coupled in a manner so that the displacement means is moveable relative to the support structure. The support structure may have three legs that are arranged in a tripod arrangement.

The present invention provides in a seventh aspect a probe for non-destructive testing of items, the probe being movable over the surface of a test item and comprising

a receiver for receiving a return signal from the non-destructive testing of the item and

a displacement means for providing a displacement signal indicative of the spatial displacement of the probe over the test item as the probe is moved over the test item and

a support structure for supporting the displacement means over the surface of the test item

wherein the support structure comprises legs that are arranged in a tripod arrangement.

The invention will be more fully understood from the following description of specific embodiments. The description is provided with reference to the accompanying drawings.

### BRIEF DESCRIPTION OF THE DRAWINGS

FIG. 1 is a schematic diagram of a system in accordance with an embodiment;

FIG. 2 is a cross-sectional view through a NDT probe in accordance with an embodiment;

FIG. 3 is a schematic diagram of a probe in accordance with an embodiment;

FIG. 4 is a cross-section through a prior art pitch/catch probe for NDT testing;

FIGS. 5 shows a schematic representation of a probe for non-destructive testing in accordance with an embodiment;

FIGS. 6-7 show views of portions of the probe shown in FIG. 5; and

FIG. 8 is a schematic block diagram of components of the probe according to an embodiment.

### DETAILED DESCRIPTION OF SPECIFIC EMBODIMENTS

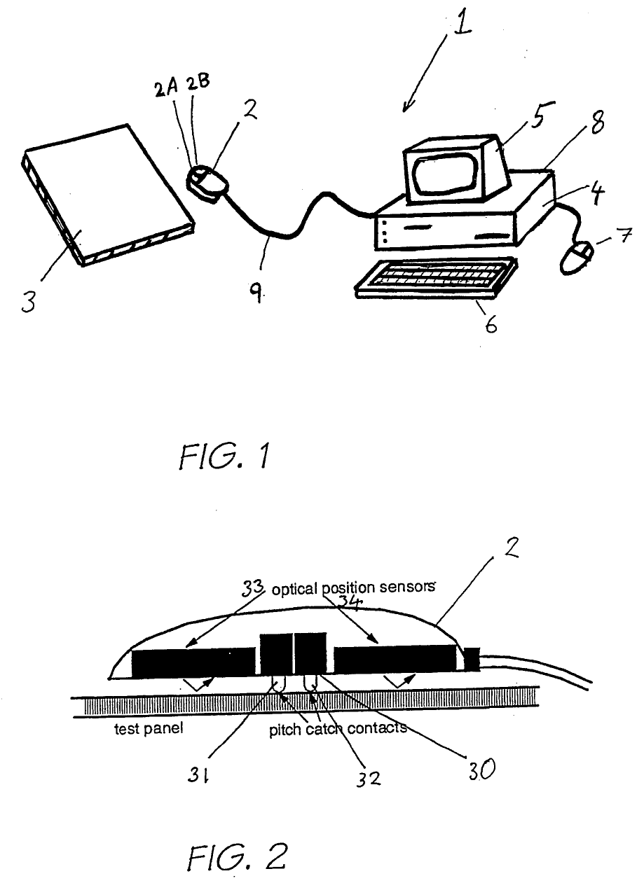

Referring to FIG. 1, there is illustrated a non-destructive testing apparatus in accordance with an embodiment, generally designated by reference numeral 1.

The apparatus includes a NDT probe 2 in accordance with an embodiment. The probe 2 is arranged to be passed over a test sample 3 and to provide an acoustic vibration signal of a drive frequency within the range of 5 to 70 kHz to the sample 3 and receive a return signal to be processed by the computing system 8 to provide data on any faults in the test sample 3.

In operation, the test sample will usually be a part of equipment being tested, such as an aeroplane, for example.

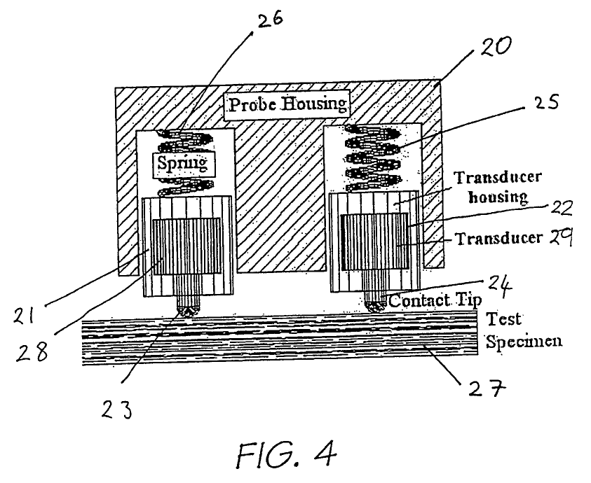

Referring to FIG. 2, the probe 2 comprises a pitch/catch arrangement 30. The pitch/catch arrangement 30 includes pitch/catch assemblies 31 and 32 which are equivalent to the pitch/catch assemblies 21 and 22 which are described in the preamble with reference to FIG. 4. The operation of the pitch/catch arrangement 30 of the probe 2 is the same as that of the prior art pitch/catch arrangement and no further description will be given.

In addition to the pitch/catch arrangement 30, the probe 2 also mounts displacement means 33 and 34. In this embodiment, the displacement means 33 and 34 comprise two optical systems 33 and 34 which are equivalent to those used in the so-called “optical” computer mouse. These optical systems operate by continuously forming an image of a small area of the test surface 3 beneath the probe 2. As the image is updated two-dimensional cross correlation is calculated using the natural “texture” of whatever is in the image. The result of this is a number which expresses how far the probe has moved between images. By utilising two of the optical systems 33 and 34 a vector for the movement of the probe 2 can be calculated. A computer 4 (see later) calculates this vector from the displacement signal provided by the optical systems. Because there are two optical systems, orientation information is provided enabling the vector to be calculated.

Note that the probe provides displacement information and that the processing to provide the positional information takes place in computing system 3 (to be described later).

The probe 2 also has “mouse buttons” 2A and 2B. These are associated with sensors so that when the buttons 2A, 2B are actuated a signal is sent back to computing system 8.

In use, a user of the probe 2 sets a “datum” on the test sample 3 from which all dimensional information may be mapped. The probe 2 can then be moved anywhere and the NDT reading taken, or the readings can be taken continuously as the probe is moved (these various options can be implemented using the probe buttons). If the probe 2 is lifted off the test piece 3 clicking on the datum re-establishes the co-ordinate system. The calculation of a vector rather than simply the distance the probe 2 has moved means that the user can rotate the mouse without distorting the co-ordinate system.

The data may comprise a reflective detector spot or a number of reflective detector spots on the panel and an LED/detector on the probe. Reflective spot provides point of reference. The spot may be matt, depending upon whether the panel has a shiny surface.

Note that normal mouse function is retained in mouse 7 connected to the computing system, and control can be switched back and forth between the probe 2 and the mouse 7 according to user demand.

As well as the probe 2 the system also includes a computing system 8 including a computer 4, display 5, keyboard 6 and mouse 7. Software is provided for the computing system 8 to process the signals from the optical sensors 33 and 34 and also the signals from the pitch/catch probe arrangement 30.

The computing system 8 may process the signals from the pitch/catch probe 30 in any conventional way known in the prior art, to provide information on defects within the test sample 3 as the probe 2 is passed over the test sample. Preferably, however, the signals are processed in accordance with the method of the invention described in the applicants co-pending application entitled “Method and Apparatus for Carrying Out Non-Destructive Testing of Materials”, filed on the same day as the present application, and the disclosure of which is incorporated herein by reference.

Software may be provided to control a computing system 8 to process the displacement signals from the optical systems 33 and 34 to provide position information as discussed above. This position information can be stored in the computer along with the result of the processing of the pitch/catch signals, so that a positional map of the sample may be provided showing any defects therein, on display 5.

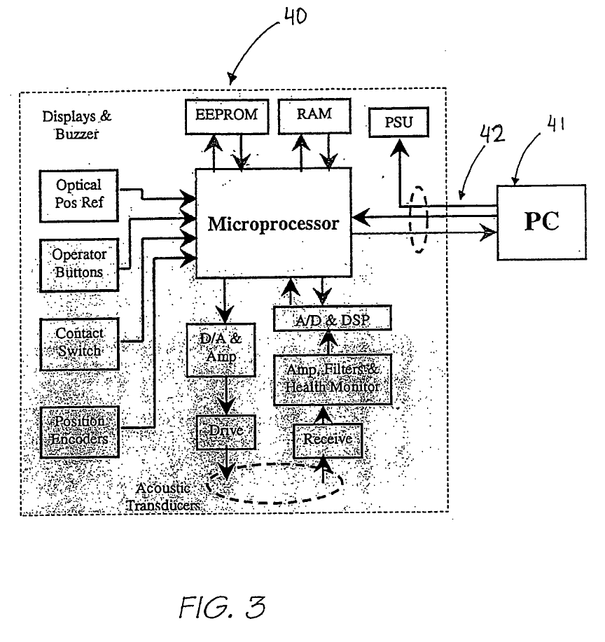

Referring to FIG. 3, there is illustrated a non-destructive testing (NDT) system in accordance with an embodiment. The system includes a NDT probe 40 and a PC computer 41. The probe 40 comprises all NDT data acquisition, processing and analysis electronics in one housing. The PC computer 41 functions to store and display data. The probe is operatively connected with the computer using a single USB cable 42. The probe can be connected to any typical standard PC computer via a USB port which gives the probe a significant commercial advantage. In this case the USB cable may also be used to supply electrical power.

In operation, the test sample will usually be a part of equipment being tested, such as an aeroplane, for example.

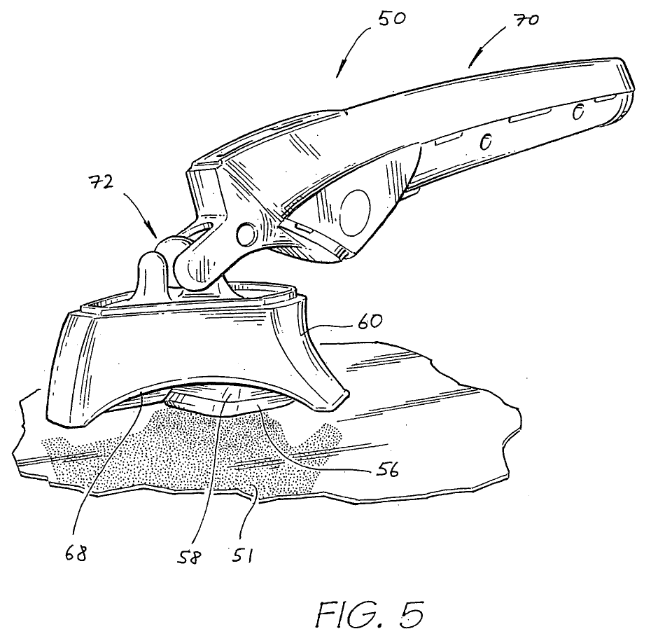

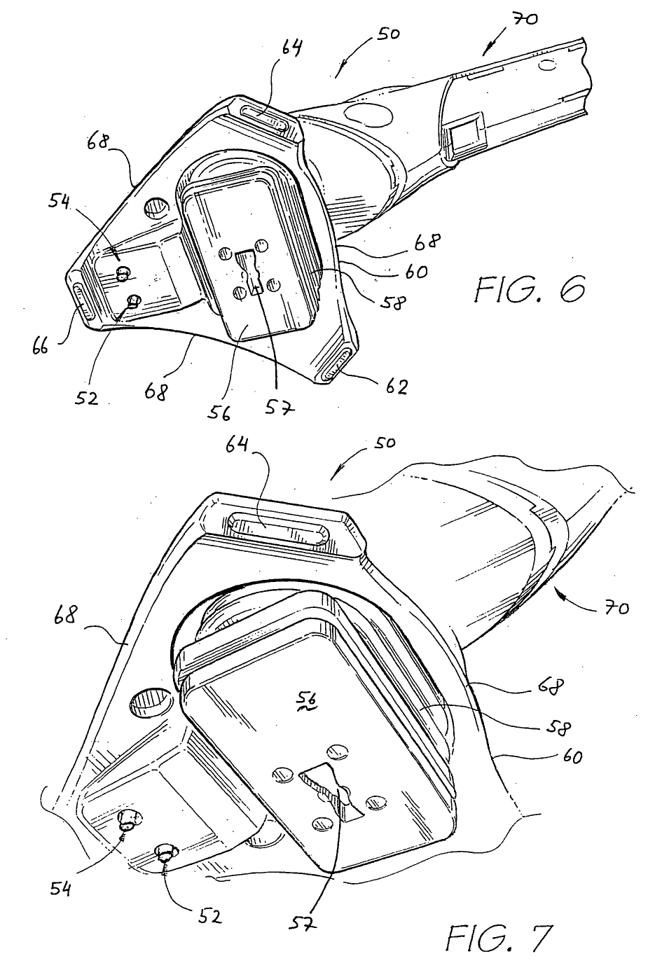

Referring to FIGS. 5 to 7, there is illustrated a probe for non-destructive testing in accordance with another embodiment, generally designated by reference numeral 50.

The probe 50 is arranged to be passed over a test sample 51, which shows a reflection of the of the probe, and to provide an acoustic vibration excitation of a drive frequency within the range of 1 to 70 kHz to the sample 51 and receive a return signal to be processed by the computing system (not shown) to provide data on any faults in the test sample. The acoustic vibration excitation may be of single frequency or may be a broad-band excitation such as a band-limited broad-band excitation. A return signal detected from a damaged test sample is compared with that from a “good” test sample (to give a reference signal) to determine the extent of any damage to the test sample. In one embodiment the probe 50 is arranged to store reference signals so that the same reference signal can be used for continued testing of a tests item or for different test items of the same type.

The probe 50 comprises pitch/catch assemblies 52 and 54 of the probe 50. Each assembly includes contact tips which are spring loaded to contact a test sample and is equipped with a transducer such that one can act as a driver and the other as a detector. The available drive frequency range is wide, typically 1 to 70 kHz. The drive signal is generally a short wave train, up to 6 cycles of sinusoid at a user selected frequency within the above range.

In addition to the pitch/catch assemblies 52 and 54, the probe 50 comprises a displacement device 56 that provides information about the displacement of the probe when the probe is moved over the surface of a test item. In this embodiment, the displacement device 56 comprises an optical system in a housing and the optical system is equivalent to those used in the so-called “optical” computer mouse. The housing has a lower surface having an opening 57 through which the optical sensor operates.

The displacement device 56 is mounted by a flexible mounting 58 to a support structure 60. In this embodiment, the flexible mounting 58 comprises a resilient material that allows movement of the displacement device 56 in any direction relative to the support structure 60. In this case the resilient material is a rubber type material connecting the support structure 60 with the housing of the displacement device 56. Alternatively, however, the flexible mounting may be a mechanical arrangement comprising parts which function as a whole so that the mounting is flexible.

The support structure 60 has three sliding feet 62, 64 and 66 which form part of a tripod arrangement. The sliding feet 62, 64 and 66 which are linked by a bridge portion that is a part of the support structure 60. The displacement device is positioned at a central portion of the area circumscribed by the three feet. The support structure has arc-shaped cut-outs 68.

In this embodiment, a handle portion 70 is connected to the support structure 60 by a universal joint 72 that allows pivotable movement about itself in all directions. The universal joint is covered by a flexible rubber sleeve which is not shown. In one embodiment, the handle portion 70 is arranged for connection to an extension pole or is extendable which has advantages when the test item is not easily accessible (eg areas of an aircraft which are difficult to reach).

In use the probe 50 may be moved over the surface of the test item, such as an aircraft panel, having a curved surface and, for example, the curvature of the surface may change across the surface. The three feet 62, 64 and 66 are sliding on the surface and because of the tripod arrangement it may be possible to follow the curvature of the surface while at the same time all of the three sliding feet are in contact with the surface of the test item. The displacement device 56 is flexibly mounted on the support structure 60 and in use the lower surface of housing of the displacement device is in contact with the surface. Due to the flexible mounting, contact of the lower surface of the housing with the surface of the test item can be maintained even if the curvature of the surface changes as the displacement means can move (ie. up or down) relative to the support structure 60. It is therefore possible to obtain relatable displacement information even if the probe is moved over a curved surface having a changing curvature.

The probe is arranged so that in use the universal joint 72 is at a relatively low level over the surface of a test item. In this embodiment, the universal joint 72 positioned so that the distance between the sliding feet 62, 64 and 66 is larger than the height of the universal joint 72 over the surface of the test item. This arrangement has the advantage that it is possible to move the probe over the surface of the test item in a relatively stable manner and the likelihood of tipping is reduced.

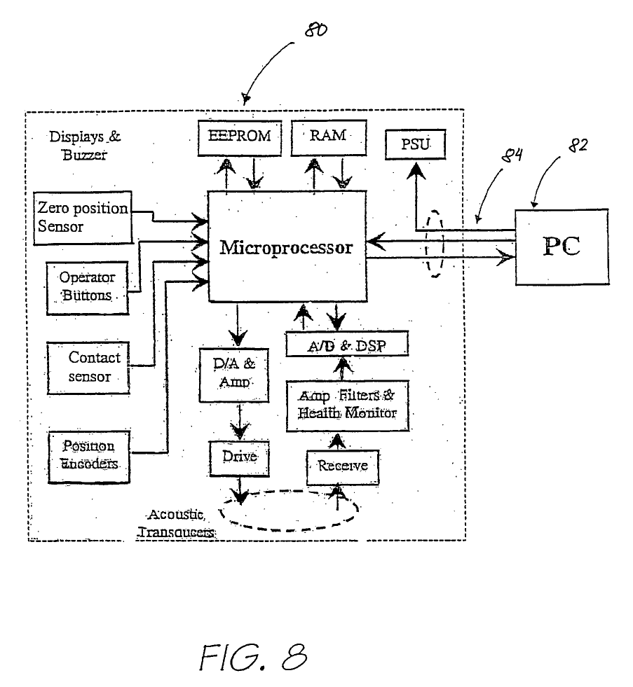

FIG. 8 shows a schematic block-diagram of electronic components of the probe 50 shown in FIGS. 5 to 7. The probe 80 comprises NDT data acquisition, processing and analysis electronics in one housing. PC computer 82 functions to store and display data. The probe is operatively connected with the computer 82 using a single USB cable 84. The probe can be connected to any typical PC computer via the USB port which gives the probe a significant commercial advantage. In this case the USB cable may also be used to supply electrical power.

Alternatively, the probe may be battery-powered and the data transfer between probe 80 and computer 82 may be wireless in which case the device does not need a USB cable connection.

In the above description, the probe incorporates a pitch/catch arrangement. It will be appreciated that the present invention is not limited to use of a pitch/catch arrangement. Any NDT sensor arrangement which can be incorporated in the probe may be utilised (e.g. ultrasonic pulse echo, eddy current, mechanical impedance).

The particular embodiment of the probe described above utilises optical arrangements for providing positional information. It will be appreciated that the present invention is not limited to optical arrangements, and any sensor arrangement which enables the provision of positional information from motion of the probe may be utilised. For example, an arrangement such as that of a conventional computer ball-mouse may be utilised for this purpose.

The probe described above is particularly suitable for use in non-destructive testing. The probe is not limited to the NDT field, however. Any process or system which requires the input of positional information from a probe could utilise the probe of the present invention.

Further, the probe may also comprise computer memory for data storage in one housing. In this case a connection to an external computer may only be required for data transfer. The probe may also comprise a display and may form a complete NDT system.

What is claimed is:

1. A probe for non-destructive testing of items, the probe being movable and rotatable over the surface of a test item and including a receiver for receiving a return signal from the non-destructive testing of the item and including displacement means for providing a displacement signal indicative of the spatial displacement of the probe over the test item as the probe is moved over the test item and the displacement means being arranged to provide information on the rotational orientation of the probe if the probe is rotated.

2. The probe as claimed in claim 1, wherein the displacement means includes a sensor mounted to the probe and being capable of providing the displacement signal.

3. The probe as claimed in claim 1, wherein the sensor is equivalent to sensors provided in computer mice.

4. The probe as claimed in claim 3, wherein the sensor is an optical sensor similar to those utilised in computer mice.

5. The probe as claimed in claim 2 wherein the sensor is one of two or more sensors and wherein the displacement means is arranged so that information on the rotational orientation of the probe is derived from the movement of the sensor relative to the test item.

6. The probe as claimed in claim 1 comprising non-destructive testing (NDT) data acquisition, processing and analysis electronics in one housing.

7. The probe as claimed in claim 6 wherein the probe, together with a computer for data storage and data display, forms a complete NDT system.

8. The probe as claimed in claim 6 wherein the probe is operatively connectable with the computer using a single USB cable.

9. The probe as claimed in claim 7 wherein the probe is operatively connectable with the computer using a radio USB connection.

10. The probe as claimed in claim 6 wherein the probe comprises computer memory for data storage in one housing.

11. The probe as claim in claim 10 wherein the probe comprises a display in one housing and forms a complete NDT system.

12. An apparatus for processing a signal from a probe as claimed in claim 1, to provide data on the position of the probe as it moves over a test surface.

13. A non-destructive testing system comprising a probe as claimed in claim 1 and an apparatus for processing a signal from the probe to provide data on the position of the probe as it moves over a test surface.

14. A probe for non-destructive testing of items, the probe being arranged to provide positional information of displacement of the probe over the item, the probe being movable and rotatable over the surface of the item and including a displacement sensor means for providing a displacement signal indicative of the spatial displacement of the probe over the test item, the displacement sensor means also being arranged to provide information on the rotational orientation of the probe if the probe is rotated.

15. The probe as claimed in claim 14 comprising data acquisition, processing and analysis electronics in one housing and the probe forming, in combination with a typical standard computer, a useable NDT system.

16. A probe for non-destructive testing of items, the probe being movable over the surface of a test item and comprising
a receiver for receiving a return signal for the non-destructive testing of the item and
a displacement means for providing a displacement signal indicative of the spatial displacement of the probe over the test item as the probe is moved over the test item and
a support structure for holding the displacement means over the surface of the test item,
wherein the support structure and the displacement means are coupled in a manner so that the displacement means is moveable relative to the support structure.

17. The probe as claimed in claim 16 wherein the displacement means includes a housing having a lower surface and the support structure is arranged to hold the lower surface of the housing on the surface of the test item.

18. The probe as claimed in claim 16 having a flexible coupling that couples the displacement means to the support structure.

19. The probe as claimed in claim 16 wherein the support structure has three legs with feet that are arranged in a tripod arrangement.

20. The probe as claimed in claim 17 wherein the support structure has three legs that are arranged in a tripod arrangement and wherein in use the three feet slide across the surface of a curved test item and the lower surface of the displacement means maintains contact with the surface even if the curvature of the surface is changing.

21. The probe as claimed in claim 16 further comprising a handle portion and the handle are connected to the support structure by a pivotable connection.

22. The probe as claimed in claim 21 wherein the handle portion is connected to the support structure so that the area circumscribed by support positions at which in use the support structure contacts the surface of the test item has a diameter larger than the height of the pivotable connection over the area.

23. A probe for non-destructive testing of items, the probe being movable over the surface of a test item and comprising
a receiver for receiving a return signal from the non-destructive testing of the item and
a displacement means for providing a displacement signal indicative of the spatial displacement of the probe over the test item as the probe is moved over the test item and
a support structure for supporting the displacement means on the surface of the test item
wherein the support structure comprises legs that are arranged in a tripod arrangement.

24. A probe for non-destructive testing of items, the probe being movable over the surface of a test item and comprising
a receiver for receiving a return signal for the non-destructive testing of the item and
a displacement means for providing a displacement signal indicative of the spatial displacement of the probe over the test item as the probe is moved over the test item and
a support structure for holding the displacement means over the surface of the test item,
such that, when the support structure is moved over the surface of the test item, a substantially constant distance is maintained between the displacement means and the surface of the test item.

25. The probe as claimed in claim 24 wherein the support structure and the displacement means are coupled in a manner so that the displacement means is moveable relative to the support structure.

26. The probe as claimed in claim 24 wherein the support structure has three legs that are arranged in a tripod arrangement.
